(19) United States
(12) Patent Application Publication
(10) Pub. No.: US 2025/0384720 A1
(43) Pub. Date: Dec. 18, 2025

(54) Method for analyzing faults in a vehicle, and vehicle

(71) Applicant: AUDI AG, Ingolstadt (DE)

(72) Inventors: Kerstin BASKAKOW, Schernfeld (DE); Matthias SCHNEIDER, Schernfeld (DE)

(73) Assignee: AUDI AG, Ingolstadt (DE)

(21) Appl. No.: 19/236,356

(22) Filed: Jun. 12, 2025

(30) Foreign Application Priority Data
Jun. 13, 2024 (DE) 10 2024 116 554.5

(51) Int. Cl. G07C 5/08; G07C 5/00

(52) U.S. Cl. CPC G07C 5/0808; G07C 5/008

(57) ABSTRACT

A method of simplifying and/or improving a fault analysis in a vehicle may include, in a transmission period starting with establishment of a data connection and ending with the interruption of the data connection, when the ignition of the vehicle is active and/or when the vehicle is moving, transmitting the in-vehicle data as transmission data to the transmission control unit in addition to a transmission of the in-vehicle data between at least two components. In addition, the transmission data arriving at the transmission control unit are forwarded to the external computing unit via the data connection. In addition, a description of a fault pattern present in the vehicle and fault data from a fault memory of the vehicle are transmitted to the external computing unit. On the basis of the fault pattern, the transmission data forwarded to the external computing unit and the fault data, a fault analysis is carried out during the existence of the data connection and/or within a period after the existence of the data connection.

### CROSS-REFERENCE TO RELATED APPLICATIONS

This application claims the priority benefit of German Patent Application No. 10 2024 116 554.5 filed on Jun. 13, 2024, which is incorporated by reference herein in its entirety.

### BACKGROUND

### 1. Field

An invention relates to a method for simplifying and/or improving a fault analysis in a vehicle and to a vehicle which is configured to carry out the method for simplifying and/or improving a fault analysis, according to described examples.

### 2. Description of the Related Art

If a fault message is displayed in a vehicle, that is to say there is a fault, for example by virtue of an indicator light lighting up, in particular in the area of the dashboard, and/or a message being displayed on a display integrated in the vehicle, and/or if there is a problem with the vehicle, it is possible, in accordance with the prior art, to communicate with service personnel from the vehicle via online communication, which is referred to as a breakdown call. When communicating with the service personnel, fault data stored in a fault memory of the vehicle can be transmitted to service personnel while the vehicle is at a standstill.

The fault data are data relating to malfunctions and/or technical defects, in particular in the field of technology, mechanics, sensors and/or electronics, in the vehicle. For this purpose, each and/or some of the control units in the vehicle respectively check(s) data entering and/or leaving the control unit for plausibility and/or possible faults, for example. This means that at least some of the data transmitted within the vehicle are checked in order to determine whether these data correspond to expected data and/or whether these data deviate from the data normally transmitted, in particular in terms of content, for example by their measured value. The expected data are data transmitted during normal operation of the vehicle and/or during operation of the vehicle in a faultless state. In other words, at least some of the data transmitted within the vehicle are checked for irregularities. If a deviation and/or irregularity is detected, i.e.

a fault is detected, an entry is made in the fault memory. An entry in the fault memory can be made in particular as a code and/or can indicate the vehicle component in which the trigger for storing the fault data (fault) was located.

Fault data relating to a fault (trigger for storing the fault data) that are stored in the fault memory are stored in particular until the fault has ceased to occur within a predefinable number of driving cycles (switching the ignition on and off) and/or until the fault memory is reset or erased, in particular by a diagnostic tester and/or a data logger and/or a vehicle diagnostic system, for example by inputting a command to erase the fault memory. In particular, the fault memory comprises fault data relating to a plurality of journeys.

The described method is disclosed, for example, in DE 10 2015 012 524 A1. The document discloses a method for carrying out a diagnosis on a vehicle, in which a central computing unit accesses a vehicle computer via a wireless connection.

The disadvantage of this is that not only current faults are transmitted, but also faults that occurred during past journeys, and only the corresponding fault data are transmitted, but no further data are available at a time at which the fault occurred.

DE 10 2017 124 021 A1 discloses a method for automatically controlling a vehicle during a parking process, wherein it is detected whether the vehicle enters a fail-safe mode and, in response to the vehicle entering the fail-safe mode, a communication channel is established between the remote assistance station and the vehicle.

DE 10 2020 128 497 A1 discloses a computer-implemented method for the dialog-supported remote diagnosis of a defect in a technical component part and/or system of a vehicle by classifying natural language data of a description of the defect by a classification algorithm. This also results in disadvantages due to the small amount of data for analyzing the defect or fault.

### SUMMARY

The invention according to the described examples is based on example objects of providing the best possible basis for fault analysis in a vehicle, so that a cause of the fault can be determined as reliably as possible.

The examples objects may be achieved by the subject matter of the independent patent claims. Advantageous developments of the invention according to the examples may be described by the dependent patent claims, the following description and the figures.

As a solution, the invention according to the examples comprises a method for simplifying and/or improving a fault analysis in a vehicle, wherein the vehicle comprises at least two components, a bus system and a transmission control unit. The component may be, for example, a control unit and/or an in-vehicle memory and/or a sensor. In particular, the at least two components are connected to each other via the bus system and can exchange data with each other via the bus system. The data transmitted between the at least two components via the bus system are referred to as in-vehicle data. The transmission control unit is configured to communicate with an external computing unit. The external computing unit is, for example, at least one server, in particular of a cloud computing provider, and/or at least one computer. In particular, the transmission control unit can forward incoming data to the external computing unit and can thereby transmit in-vehicle data, which are transmitted internally in the vehicle, as transmission data to an external computing unit which is in particular independent of the vehicle.

When an activation command is detected by the vehicle, the transmission control unit of the vehicle establishes a data connection between the vehicle and the external computing unit. For example, the data connection can be a connection via a mobile radio network. In particular, the data connection may be a connection standardized by the 3GPP (3rd Generation Partnership Project) standardization organization, in particular 2G-GSM, 3G-UMTS, 4G-LTE and/or 5G-NR and/or a newer technology. Additionally or alternatively, the data connection may be a VPN (Virtual Private Network) connection.

When an abort criterion is detected by the vehicle and/or the transmission control unit and the data connection exists, the data connection is interrupted. The abort criterion can be a user input, in particular an input of a command and/or voice command and/or actuation of a button on the vehicle by a vehicle occupant, and/or the expiry of a predefinable time period, for example a maximum of 15 minutes, in particular a maximum of 10 minutes, or for example a maximum of 5 minutes. The data connection can be interrupted for a predefinable period, for example a maximum of 15 minutes, in particular a maximum of 10 minutes, or for example a maximum of 5 minutes, wherein the data connection is established again after the predefinable period. Additionally or alternatively, the interruption of the data connection may be an abort of the data connection, with the result that it is necessary to establish a data connection by detecting the activation command for restoring the data connection.

In a transmission period starting with the establishment of the data connection and ending with the interruption of the data connection, i.e. in the period in which the data connection exists and/or has been established, when the ignition is active and/or when the vehicle is moving, the in-vehicle data are transmitted to the transmission control unit in addition to the transmission between the at least two components. In particular, the additional transmission of the in-vehicle data to the transmission control unit is carried out only and/or exclusively within the transmission period. The in-vehicle data are therefore transmitted within the transmission period analogously to outside the transmission period between the at least two components, wherein an additional copy of the in-vehicle data is transmitted as transmission data to the transmission control unit within the transmission period. In an example, the transmission period comprises that time at which the fault occurs. For example, the vehicle can be brought within the transmission period, in particular by the driver and/or a vehicle occupant and/or an assistance system, into the same and/or a similar situation in which the fault has already occurred beforehand.

In an example, not all but only some of all the data transmitted within the vehicle are additionally transmitted to the transmission control unit as in-vehicle data. In an example, it is possible to select, for example by a vehicle occupant and/or via the external computing unit and/or by a person assigned to the external computing unit, which data transmitted in the vehicle are additionally transmitted to the transmission control unit as in-vehicle data. In particular, at least one component can be selected, with the result that all the data sent and/or received by the component are additionally transmitted to the transmission control unit as in-vehicle data.

The transmission data arriving at the transmission control unit, i.e. those copies of the in-vehicle data which are transmitted to the transmission control unit, are forwarded to the external computing unit via the data connection. In particular, the transmission data arriving at the transmission control unit may be forwarded substantially immediately to the external computing unit. This means that, between the arrival of the transmission data at the transmission control unit and the forwarding of the transmission data to the external computing unit, a predefinable time period is not exceeded, that is to say the forwarding is carried out within the predefinable time period. The predefinable time period is in particular a maximum of 2 minutes, in particular a maximum of 1 minute, a maximum of 30 seconds, or a maximum of 15 seconds.

In addition, a description of a fault pattern present in the vehicle is transmitted to the external computing unit. This may be, for example, a description of a behavior of the vehicle that deviates from the normal behavior and/or the description of a fault message displayed in the vehicle and/or the indication of the indicator light that lights up in the area of the dashboard of the vehicle. In particular, the description is a written and/or spoken message from at least one vehicle occupant, which is transmitted to the external computing unit, for example via a mobile radio connection and/or via an Internet connection and/or via the data connection.

In addition, fault data, as already described elsewhere in the application, are transmitted from a fault memory of the vehicle to the external computing unit via the data connection. In particular, all and/or some of the fault data stored in the fault memory are transmitted to the external computing unit. If only some of the fault data are transmitted, that portion of the fault data which has been stored within a predefinable time interval is transmitted, in particular. In an example, the predefinable time interval ends with the time at which the fault data are transmitted. In an example, the predefinable time interval begins, for example, at least 10 minutes, or at least 30 minutes, or at least 2 hours, or at least 1 day, before the time at which the fault data are transmitted.

On the basis of the fault pattern, the transmission data forwarded to the external computing unit and the fault data, a fault analysis is carried out, during the existence of the data connection and/or within a predefinable period after the existence of the data connection, by determining a cause of the fault pattern. The fault analysis can be carried out, for example, on the basis of the fault data by a method known from the prior art. For example, it is possible to determine the component in which the fault occurred, by the external computing unit and/or a person operating the external computing unit, from the fault data and a fault time to be taken from the description, i.e. that time at which the fault occurred. This can be carried out, for example, by comparing the fault code from the fault data with a database. In addition, the transmission data can be used to determine the cause of the fault pattern. For example, when the component in which the fault occurs is known, the knowledge being able to be obtained, for example, from the fault memory, those transmission data which were transmitted as in-vehicle data between the component in which the fault occurs and at least one other component in a predefinable period, for example up to 5 minutes, in particular up to 10 minutes, for example up to 30 minutes, before and after the fault time to be taken in particular from the description, can be read into a program. By these transmission data which have been read in, larger amounts of data are available at the fault time and can be examined, for example, by a program which searches in particular for data that do not correspond to the expected data. This allows conclusions to be drawn about the fault, in particular about a faulty component part and/or a faulty component, which should be replaced and/or repaired if necessary. The analysis for faults can be carried out automatically by a computer and/or the external computing unit and/or can be carried out by a person who analyzes the data read into the program with consideration of the fault memory and the description and determines the fault in a known manner.

The advantage of the method is that more data are available for fault analysis and a fault analysis is thus simplified and/or improved, since a fault can be inferred in an improved manner and/or with greater accuracy.

The invention according to the examples also comprises developments that result in additional advantages.

One development comprises the fact that the fault pattern is described via a voice connection between a person in the vehicle and a person assigned to the external computing unit and/or the external computing unit. The voice connection may be a connection via the mobile radio network. Speech, in particular spoken words and/or sentences, and/or sounds of at least one vehicle occupant is/are transmitted to the external computing unit and/or the person assigned to the external computing unit via the voice connection. Additionally or alternatively, artificially generated speech, for example spoken words and/or speech of the person assigned to the central computing unit that is/are assembled by the central computing unit and/or artificial intelligence, can be transmitted to at least one vehicle occupant via the voice connection.

The person assigned to the external unit is in particular a person who operates the external unit, for example a person who, by use of at least one program executed, for example, on the external unit, analyzes the transmission data and/or fault data with the aid of the description of the fault pattern in order to determine the cause of the fault pattern.

The voice connection may be established by at least one vehicle occupant (person in the vehicle), for example via a cellphone belonging to the vehicle occupant and/or a hands-free system of the vehicle, which is connected to the cellphone belonging to the vehicle occupant, and/or by the vehicle itself. In particular, the voice connection is established in response to a command, for example by dialing a predefinable number and/or by pressing a button.

The advantage of the development is that a description of the fault pattern can be transmitted in a particularly simple way to the external computing unit and/or the person assigned to the external computing unit.

One development comprises the fact that the in-vehicle data are all or a predetermined selection of those data which, during the existence of the data connection, are transmitted to a fault memory in order to be stored there, and/or come from at least one control unit and/or at least one sensor of the vehicle, and/or are transmitted only within a control unit. That is to say, the in-vehicle data are in particular data that are only transmitted within the vehicle. In particular, the in-vehicle data are therefore not transmitted via a unit outside such the vehicle, for example a server. In particular, in-vehicle data are transmitted to a unit outside the vehicle, in the present case to the external computing unit, only via the transmission control unit, wherein the data transmitted via the transmission control unit are referred to as transmission data. The transmission data may be the in-vehicle data and/or a subset of the in-vehicle data, the subset being able to be selected, for example, by the external computing unit and/or a person assigned to the external computing unit and/or by a vehicle occupant. In particular, the subset can be selected by determining, based on the transmitted fault data, the component which has a fault and transmitting, as transmission data, the in-vehicle data transmitted from and/or to the component which has the fault.

The advantage of the development is that the number of data items not required as transmission data is reduced, since data which have already been transmitted to an external unit can also be transmitted from this external unit to the external computing unit. As a result, a larger bandwidth is available for transmitting in-vehicle data to the external computing unit, since the total available bandwidth is not consumed by data that can also be transmitted from an external unit to the external computing unit.

One development comprises the fact that the transmission data are stored in the transmission control unit exclusively in a volatile memory. This means in particular that the time period in which the transmission data are stored in the transmission control unit is limited to the time period in which the ignition is on. This results in the advantage that the transmission data are from the driving cycle in which the data connection also exists and in which the fault occurs. This avoids unnecessary forwarding of transmission data, in particular since no data from another driving cycle in which the fault may not have occurred are transmitted.

One development comprises the fact that a time period between the arrival of the transmission data at the transmission control unit and the transmission of the transmission data via the data connection is shorter than the transmission period. In particular, the time period between the arrival of the transmission data at the transmission control unit and the transmission of the transmission data via the data connection is shorter than a predefinable time period. In other words, the transmission data are forwarded by the transmission control unit within a predefinable time period. The predefinable time period is in particular a maximum of 2 minutes, in particular a maximum of 1 minute, for example 30 seconds, for example a maximum of 15 seconds. This results in the advantage that a fault analysis can be carried out as soon as possible, since the transmission data are transmitted, for example, within the predefinable time period.

One development comprises the fact that at least one instruction for performing a functionality and/or a driving maneuver is provided in the vehicle. This means, for example, that the instruction is transmitted to the vehicle by the external computing unit and/or a person assigned to the external computing unit. For example, the transmission can be carried out via a voice connection and/or via the data connection. The instruction comprises, in particular, an instruction that at least one driving maneuver specified by the instruction is to be carried out and/or a functionality specified by the instruction is to be carried out. For example, the instruction may comprise activating a function, for example a driving function and/or a driver assistance system, and/or activating a function via an infotainment system of the vehicle. In particular, the instruction comprises the fact that a driving maneuver and/or a functionality, during which a fault has previously occurred, is/are performed, for example within the transmission period. The execution of the instruction is therefore intended, in particular, to cause a fault again that has already been observed and/or has already occurred. The instruction may be executed by at least one vehicle occupant and/or by a driver assistance system and/or by an autonomously driving vehicle. In particular, if the driver assistance system and/or the autonomously driving vehicle execute(s) the instruction, it may be provided that the instruction is executed automatically when the instruction is received by the vehicle, that is to say, in particular, there is no waiting for a command and/or an input by at least one vehicle occupant.

Additionally or alternatively, it is provided that those in-vehicle data which are transmitted during or as a result of the execution of the at least one instruction in the vehicle are transmitted via the data connection. In particular, this means that all and/or a selectable portion of those in-vehicle data which are transmitted during the execution of the instruction within the vehicle are transmitted as transmission data to the external unit.

The advantage of the development is that it is possible to reproduce the situation, in which at least one fault occurred, as accurately as possible. In particular, this means that the fault is intentionally caused and, in particular, the transmission data are transmitted for fault analysis during the occurrence of the fault. This allows more data to be provided for the fault analysis if the fault reoccurs based on the transmission data, thus improving and/or facilitating the fault analysis, in particular.

One development comprises the fact that the data connection is a connection via a mobile radio network for transmitting data. In particular, the data connection may be a connection standardized by the 3GPP (3rd Generation Partnership Project) standardization organization, in particular 2G-GSM, 3G-UMTS, 4G-LTE and/or 5G-NR and/or a newer technology. This has the advantage that this technology is already installed in the vehicle and therefore, in particular, no costly retrofitting of the vehicle is necessary.

One development comprises the fact that the transmission control unit is an online data collector which is configured to collect and forward usage data relating to use of at least one predefinable function in the vehicle. In other words, the online data collector is configured to monitor the usage behavior of at least one predefinable function in the vehicle and, for example, to inform the vehicle manufacturer at predefinable time intervals, for example at least once a year, in particular at least once a month, or once a week, about the usage behavior of the predefinable functions, that is to say how often and/or for how long and/or how intensively and/or in which situations the at least one predefinable function was used by at least one vehicle occupant. If the online data collector is used as a transmission control unit, this has the advantage that an already installed control unit, which has the functionality of transmitting data to an external unit, for example the external computing unit, necessary for the transmission control unit, is used, thus making it possible to save, in particular, the costs and/or effort and/or space involved in installing and/or integrating an additional transmission control unit (in addition to the online data collector).

One development comprises the fact that the transmission data, in addition to the in-vehicle data, comprise image and/or video data from at least one camera included in the vehicle and/or the contents displayed on at least one screen present in the vehicle. The contents displayed on at least one screen present in the vehicle can be recorded, for example, by a mobile terminal, for example a smartphone and/or a tablet and/or a smartwatch equipped with a camera and/or a camera, can be transmitted to the vehicle by a method known from the prior art (for example Bluetooth) and can be forwarded from the vehicle to the external computing unit as transmission data. Additionally or alternatively, the contents displayed on at least one screen present in the vehicle can be captured by at least one interior camera of the vehicle. Additionally or alternatively, at least one screenshot can be recorded, in particular in response to a command from at least one vehicle occupant and/or the external computing unit and/or a person assigned to the external computing unit. This can be particularly useful if, due to the fault, at least one item of information is displayed on at least one screen present in the vehicle. In an example, the at least one item of information displayed due to the fault is represented in the image and/or video data and/or contained in the data of the contents displayed on at least one screen present in the vehicle.

This results in the advantage that a photographic representation of the fault can be transmitted to the external computing unit, thereby making it possible to describe the fault pattern present in the vehicle in a particularly effective and accurate manner.

One development comprises the fact that the data connection is established only in response to an activation command, wherein the activation command is a signal that is transferred to the vehicle and/or a voice and/or haptic input by at least one vehicle occupant and/or a password input, in particular by a vehicle occupant, and/or a code that is input on at least one screen in the vehicle and is transmitted to at least one vehicle occupant via the voice connection. This results in the advantage that no data can be transmitted without the consent of at least one vehicle occupant. In particular, this increases security, in particular with regard to data protection and/or the dissemination of personal data.

One development comprises the fact that, after the fault analysis, the cause of the fault pattern is treated by a software update for that software and/or a part of the software which is selected on the basis of the fault analysis. This means in particular that, if the fault analysis reveals that the fault is a fault in the software, a software update will be carried out with rectification of the fault. In an example, a faulty part of the software is identified and the software update includes an improved version of the part of the software identified as faulty. In particular, the software update is a software update which is carried out remotely, that is to say can be carried out in particular by a vehicle occupant, for example without visiting a workshop. In particular, the software update is carried out only for that functionality in which the fault was determined.

This results in the advantage of a particularly fast resolution of the fault in a manner convenient for the at least one vehicle occupant. In particular, a stay of the vehicle in the workshop is avoided, as a result of which the vehicle is continuously available to the at least one vehicle occupant.

Additionally or alternatively, the development comprises the fact that, after the fault analysis, a workshop appointment is arranged, wherein the cause of the fault pattern is transmitted to the workshop and parts required for a repair are made available in the workshop based on the cause of the fault pattern. This results in the advantage that a fault analysis is not only carried out in the workshop and that the required parts are only ordered after the fault analysis in the workshop. The development results in particular in the advantage that the time spent in the workshop is minimized, since the vehicle is not in the workshop while waiting for parts and/or spare parts required for the repair.

For applications or application situations which may arise in the method and are not explicitly described here, provision may be made according to the method for a fault message and/or a request to input user feedback to be output and/or a default setting and/or a predetermined initial state to be set.

As a further solution, the invention according to the examples comprises a system comprising a vehicle and an external computing device, which is configured to carry out the method according to the examples of the invention for simplifying and/or improving a fault analysis in the vehicle.

The control apparatus for the vehicle is also included in the examples of the invention. The control apparatus may comprise a data processing apparatus or a processor device (processor circuit) configured to carry out a method according to the examples of the invention. For this purpose, the processor device can have at least one microprocessor and/or at least one microcontroller and/or at least one FPGA (field-programmable gate array) and/or at least one DSP (digital signal processor). In particular, a CPU (central processing unit), a GPU (graphical processing unit) or an NPU (neural processing unit) can each be used as the microprocessor. Furthermore, the processor device can have program code which is configured when executed by the processor device, to carry out the method according to the examples of the invention. The program code can be stored in a data memory of the processor device. The processor device may be based, for example, on at least one circuit board and/or on at least one SoC (system on chip).

The invention according to the examples also includes developments of the vehicle according to the examples of the invention which have features as have already been described in connection with the developments of the method according to the examples of the invention. For this reason, the corresponding developments of the vehicle according to the examples of the invention are not described again here.

The vehicle according to the examples of the invention may be in the form of an automobile, in particular a passenger vehicle or truck, or in the form of a minibus or motorcycle.

As a further solution, the invention according to the examples also comprises a computer-readable storage medium comprising program code which, when executed by a computer or a computer network, causes the computer or the computer network to carry out a method according to the examples of the invention. The storage medium may be provided at least partially as a non-volatile data memory (for example as a flash memory and/or as an SSD—solid state drive) and/or at least partially as a volatile data memory (for example as a RAM-random access memory). The storage medium may be arranged in the computer or computer network. However, the storage medium may also be operated, for example, as what is known as an app store server and/or cloud server on the Internet. The computer or computer network can be used to provide a processor circuit with, for example, at least one microprocessor. The program code may be provided as binary code and/or as assembler code and/or as source code of a programming language (for example C) and/or as a program script (for example Python). The computer-readable storage medium can alternatively be realized by a signal with computer-readable data, e.g. a time-varying voltage signal and/or a radio signal.

The invention according to the examples also comprises the combinations of the features of the described examples. The invention according to the examples thus also comprises implementations which have a respective combination of the features of several of the described examples, unless the examples have been described as being mutually exclusive.

### BRIEF DESCRIPTION OF DRAWINGS

Examples of the invention are described below with reference to the figure in which:

FIG. 1 shows a schematic representation of a system according to an example of the invention.

### DESCRIPTION

The examples explained below are examples of the invention. In the examples, the described components of the examples each represent individual features that should be considered independently of one another and that each also develop the examples independently of one another. The disclosure is therefore also intended to comprise combinations of the features of the examples other than those illustrated. Furthermore, the described examples can also be supplemented by more of the features of the examples of the invention that have already been described.

In the figure, identical reference signs each denote functionally identical elements.

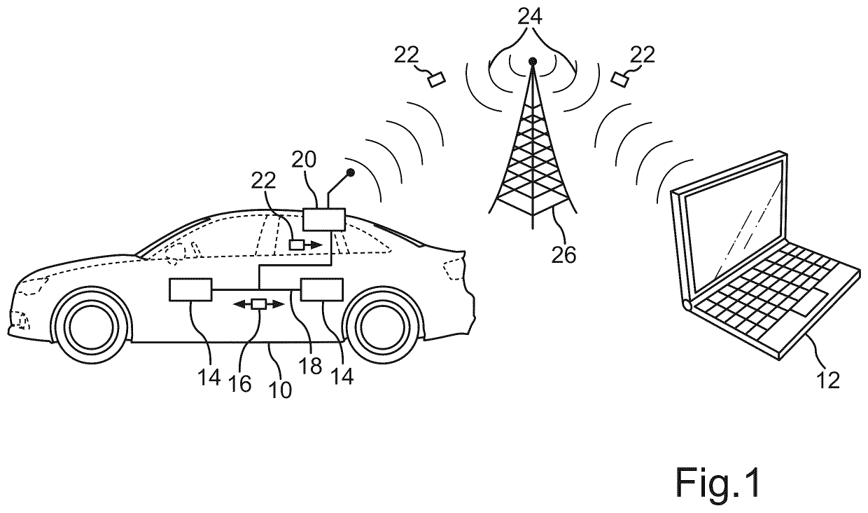

FIG. 1 shows a schematic representation of a system according to an example of the invention. For this purpose, FIG. 1 shows a vehicle 10 and an external computing unit 12. The external computing unit 12 is illustrated in the case of FIG. 1 as a laptop and/or computer, but it is not to be ruled out that the external computing unit 12 is a computer-based unit for processing and/or receiving data, such as a server and/or a computer and/or a computing center.

The vehicle 10 comprises at least two components 14, between which in-vehicle data 16 are transmitted via a bus system 18. In addition, the vehicle 10 comprises a transmission control unit 20, to which transmission data 22 can be transmitted. The transmission control unit 20 can be, for example, an online data collector which is configured to determine data relating to the use of at least one function in the vehicle 10 by at least one vehicle occupant, thus making it possible to determine the usage behavior of the at least one function. In addition, the online data collector can transmit the captured data to an external unit.

Based on the system according to the example of the invention shown in FIG. 1, a method according to an example of the invention shall be described below based on FIG. 1.

An activation command can be received by the vehicle 10. The activation command may be, for example, a signal which is transferred to the vehicle 10, for example an optical and/or haptic input by at least one vehicle occupant, a password input and/or a code provided by the external unit.

The activation command may be given when a fault is recreated. The fault is, for example, a fault message displayed on a screen included in the vehicle 10, an indicator light that lights up, and/or a malfunction, for example in the field of technology, electronics, mechanics and/or sensors. In particular, it is a fault if a reaction of the vehicle 10 does not correspond to an expected reaction of the vehicle 10. In order to recreate the fault, a situation that is as similar as possible, for example the same situation as was present when the fault occurred, may be recreated. In particular, the activation command is given and/or detected before starting to recreate the situation. In order to recreate the same situation if possible, it may be provided that the driver is given instructions on how to behave in order to recreate the situation as accurately as possible. Additionally or alternatively, the instructions can be transmitted to the vehicle 10 and executed automatically by the vehicle 10, for example when activation of a functionality of the vehicle 10 and/or driving with at least one driver assistance system and/or driving in the autonomous driving mode is/are involved. In particular, when driving in the autonomous driving mode, the vehicle 10 can automatically react and/or operate and/or act on the basis of the instruction in such a way that the same situation is recreated if possible.

A transmission period begins with the detection of the activation command and ends with the detection of an abort criterion, wherein the abort criterion can be, for example, an input by at least one vehicle occupant and/or a command which is transmitted from the external computing unit 12 to the vehicle 10.

Within the transmission period, in-vehicle data 16, which are transmitted between the at least two components 14 via the bus system 18, are additionally transmitted as transmission data 22 to the transmission control unit 20. In an example, in-vehicle data 16, in particular a more selectable portion of the in-vehicle data 16, are transmitted as transmission data 22 to the transmission control unit 20. In particular, the selectable portion of the in-vehicle data 16 transmitted to the transmission control unit 20 may be the in-vehicle data 16 which are sent and/or received by a predefinable component 14. The predefinable component 14 is for example that component 14 due to which an entry was made in the fault memory and/or which is faulty. Additionally or alternatively, the in-vehicle data 16 may be data that are transmitted to a fault memory in order to be stored there and/or data that are transmitted within a control unit and/or come from at least one control unit and/or a sensor.

In addition to the in-vehicle data 16, image and/or video data from at least one camera included in the vehicle 10 and/or data of contents displayed on at least one screen present in the vehicle 10 can be transmitted to the transmission control unit 20. This means that image and/or video recordings (image and/or video data) from at least one camera of the vehicle 10 are transmitted as transmission data 22 to the transmission control unit 20. Additionally or alternatively, the information that is displayed on at least one screen mounted in the vehicle 10 can be transmitted as transmission data 22 to the transmission control unit 20. In an example, the information includes data relating to a fault.

The data transmitted to the transmission control unit 20 may be stored exclusively in a volatile memory in the transmission control unit 20 and/or are forwarded by the transmission control unit 20 within a predefinable time period. In particular, the predefinable time period is kept as short as possible, such that the transmission data 22 are forwarded as quickly as possible by the transmission control unit 20. The transmission data 22 are forwarded to the external computing unit 12 via a data connection 24, wherein the data connection 24 may be a connection via a mobile radio network 26. The transmission data 22 are thus forwarded from the vehicle 10 to the external computing unit 12 via the data connection 24.

In addition to the transmission data 22, fault data from a fault memory of the vehicle 10 and a description of a fault pattern present in the vehicle 10, that is to say the fault, are transmitted from the vehicle 10 to the external computing unit 12. The description of the fault pattern, that is to say the fault, may be transmitted via a voice connection, and so at least one vehicle occupant, for example, has contact to a person assigned to the external computing unit 12. Via this contact, the vehicle occupant can communicate with the person assigned to the external computing unit 12.

A fault analysis can be performed on the basis of the transmission data 22, the description and the fault data. The fault analysis may be performed as soon as possible after the transmission data 22 and/or fault data and/or description has/have been captured by the external computing unit 12. In particular, the fault analysis is performed during the existence of the data connection 24 or within a predefinable period after termination and/or interruption of the data connection 24.

For the fault analysis, the vehicle may be used to recreate a situation in which the fault occurred. For example, the same route can be followed and/or driven in the same speed range and/or the same functionality can be performed. In an example, the period within which the fault is recreated falls into the transmission period.

The fault data from the fault memory and the transmission data 22 can be used to determine whether and which data deviate from expected data. If data that deviate from expected data are identified, the data can be compared with the description, which for example can include how the fault becomes apparent, and it can be determined whether the deviation can lead to the behavior described in the description. If this is the case, the data that deviate from the expected data can be used to determine, for example, a component 14 and/or software functionality that is the cause of the fault. The determination of the faulty component 14 and/or software functionality may be based, for example, on the fact that the data that deviate from the expected data are sent and/or generated by that component 14 and/or software functionality that is the cause of the fault. A software functionality is a part of software running and/or executed on the vehicle 10 that implements at least one functionality and/or function in the vehicle 10. The fault analysis can be performed, for example, by a program and/or by a person and/or by artificial intelligence and/or a neural network.

If the fault is detected in a software functionality that runs and/or is executed on the vehicle 10, a software update, in particular an update of the software functionality, can be carried out in order to rectify the fault. In an example, the update of the software and/or software functionality is carried out as a remote update, that is to say it is not necessary to drive to a workshop and/or the update can be downloaded by a vehicle occupant and/or is installed automatically.

If the fault is detected in a component 14, in particular in a hardware component 14, a workshop appointment can be arranged. In particular, the workshop can be informed of the fault and/or at least one spare part, for example the component 14 which was identified as the cause of the fault, can be ordered, such that the workshop appointment takes place after the spare part has arrived at the workshop.

This can prevent and/or minimize downtimes of the vehicle 10 at the workshop.

An example of the invention shall be described below.

In the event of at least one fault message and/or a fault in the vehicle or at least one problem with the vehicle, it is now possible to communicate with service personnel from the vehicle via online communication (breakdown call). When the connection is established, the current fault memory of the vehicle is transmitted as static information and the service advisor can provide the customer with information from the fault memory report and inform them about the further procedure via a voice connection. For a further analysis, in most cases the customer is asked to drive their vehicle to a workshop. There, the fault memory is read again and the customer's problem (vehicle owner and/or vehicle occupant) is analyzed using static fault finding strategies from a customer service library.

In an example, a system and a process may be configured to grant a service advisor (the person assigned to the external computing unit) remote access to the vehicle upon confirmation by the vehicle user. This remote access (transmission of the transmission data from the vehicle (transmission control unit) to the external computing unit) is intended to make it possible, in addition to statically reading the fault memory, to also be able to perform dynamic analyses with the help of the user and/or customer and/or at least one vehicle occupant. For this purpose, in addition to the fault data, the transmission data are transmitted to the external computing unit and/or the person (service advisor) assigned to the external computing unit. For example, in particular for forwarding the transmission data to the external computing unit, an online data collector present in the vehicle can be used. Additionally or alternatively, the service advisor can be given the opportunity to play at least one ad hoc campaign on the vehicle. With the aid of the at least one ad hoc campaign, bus data (in-vehicle data transmitted via the bus system) can be extracted and can be analyzed by the service advisor. This means that the bus data and/or the in-vehicle data are transmitted as transmission data to the transmission control unit and are transmitted by the transmission control unit to the external computing unit. The service advisor can analyze the transmission data arriving at the external computing unit, in particular for at least one fault, for example by searching for data that deviate from expected data, i.e. from data that would be present with normal functionality of the vehicle.

The customer and/or vehicle occupant can agree to the service advisor's remote access (the transmission of the transmission data to the external computing unit) by a request dialog displayed on the vehicle display. In particular, it is only through an agreement that the in-vehicle data are additionally transmitted as transmission data to the transmission control unit. In particular, the customer and/or vehicle occupant has the option of terminating remote access at any time, for example externally by pressing a button. If remote access is set up and/or active, it is possible to signal to the customer and/or vehicle occupant by a permanent indication on the display that the vehicle data are currently being accessed externally and/or the transmission data are being transmitted to the external computing unit. The vehicle should be able to be used at this time and send necessary information in real time to the back-end system (external computing device) of the service advisor. In particular, while the transmission data are being forwarded from the transmission control unit to the external computing device, the vehicle can be driven and/or moved and/or used and/or a functionality can be carried out on the vehicle.

The service advisor can plan further analyses in an off-board system according to the fault description (description of the fault pattern) from the customer and/or vehicle occupant and by way of information from the static fault memory entries (fault data) and load them directly onto the vehicle using the data connection. By using the onboard data collector, bus signals (in-vehicle data transmitted via the bus system) can be directly extracted and analyzed by the service advisor in the off-board system. This provides the customer with a dedicated fault analysis and can save the journey to the workshop in the first step.

Through the remote access of the service advisor and/or the transmission of the transmission data to the external unit, the service advisor can analyze the fault, in particular live, together with the customer and/or can plan further activities, in particular following the fault analysis. If the analysis requires a workshop visit, everything necessary can already be procured in preparation for the appointment; for example, at least one spare part, in particular a component of the vehicle that is identified as faulty, can be ordered and delivered to the workshop, and the resulting time spent in the workshop is minimized for the vehicle. If the service advisor determines through the extended analysis that no workshop visit is necessary, and the problem can be solved by remote update, in particular of at least one software functionality, this can be displayed to the customer and/or vehicle occupant accordingly in the vehicle and the customer can rectify the problem independently, for example according to the existing online update logic and/or by downloading the improved software functionality and/or the update for the software functionality.

Overall, the examples show how online remote access to at least one vehicle by a service advisor can be provided for a fault analysis.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

1. A method of fault analysis in a vehicle, comprising:
when an activation command is detected by the vehicle, establishing by a transmission control unit of the vehicle a data connection between the vehicle and an external computing unit; and
when an abort criterion is detected by the transmission control unit and/or the vehicle and when the data connection exists, interrupting the data connection, wherein,
in a transmission period starting with the establishing of the data connection and ending with the interrupting of the data connection, when ignition of the vehicle is active and/or when the vehicle is moving,
in-vehicle data transmitted between at least two components of the vehicle via a bus system are transmitted as transmission data to the transmission control unit in addition to transmission of the in-vehicle data between the at least two components,
the transmission data arriving at the transmission control unit are forwarded to the external computing unit via the data connection,
a description of a fault pattern present in the vehicle is transmitted to the external computing unit via the data connection, and
fault data from a fault memory of the vehicle are transmitted to the external computing unit via the data connection,
so that on basis of the fault pattern, the transmission data forwarded to the external computing unit and the fault data, a fault analysis is carried out to determine a cause of the fault pattern, during existence of the data connection and/or within a definable period after existence of the data connection.

2. The method according to claim 1, wherein the fault pattern is described via a voice connection between a person in the vehicle and a person assigned to the external computing unit.

3. The method according to claim 1, wherein the in-vehicle data are all or a determined selection of data from among data which, during the existence of the data connection,
are transmitted to be stored in a fault memory,
come from at least one control unit and/or at least one sensor of the vehicle, or
are transmitted within a control unit among control units of the vehicle.

4. The method according to claim 1, wherein the transmission data are stored in the transmission control unit exclusively in a volatile memory.

5. The method according to claim 1, wherein a time period between the arrival of the transmission data at the transmission control unit and the transmission of the transmission data via the data connection is shorter than the transmission period.

6. The method according to claim 1, wherein at least one instruction for performing a functionality and/or a driving maneuver is provided in the vehicle and is executed by at least one vehicle occupant and/or a driver assistance system and/or by an autonomously driving mode of the vehicle, and the in-vehicle data which are transmitted during or as a result of the execution of the at least one instruction in the vehicle are transmitted via the data connection.

7. The method according to claim 1, wherein the data connection is a connection via a mobile radio network for transmitting data.

8. The method according to claim 1, wherein the transmission control unit is an online data collector which is configured to collect and forward usage data relating to use of definable functions in the vehicle.

9. The method according to claim 1, wherein the transmission data comprise, in addition to the in-vehicle data,
image and/or video data from at least one camera included in the vehicle and/or
contents displayed on at least one display screen present in the vehicle.

10. The method according to claim 1, wherein the data connection is established in response to an activation command, wherein the activation command is at least one command from among command including:
a signal that is transferred to the vehicle,
a voice and/or haptic input by at least one vehicle occupant,
a password input, or
a code that is input on at least one screen in the vehicle and transmitted to at least one vehicle occupant via a voice connection.

11. The method according to claim 1, wherein, after the fault analysis,
a cause of the fault pattern is treated by a software update for that software which is selected on basis of the fault analysis, and/or
a workshop appointment is arranged, wherein the cause of the fault pattern is transmitted to a workshop and parts required for a repair are made available in the workshop based on the cause of the fault pattern.

12. A system comprising a vehicle and an external computing device to the vehicle, which are configured to carry out the method of fault analysis in the vehicle according to claim 1.
